(19) United States
(12) Patent Application Publication
(10) Pub. No.: US 2003/0120585 A1
(43) Pub. Date: Jun. 26, 2003

(54) Confidential electronic trading and matching system incorporating execution via an auction market

(76) Inventor: Richard Rosenblatt, Irvington, NY (US)

Correspondence Address: Barnes & Thornburg, Suite 900, 750 17th Street, N.W., Washington, DC, 20006, US

(21) Appl. No.: 10/322,439

(22) Filed: Dec. 19, 2002

Related U.S. Application Data
(60) Provisional application No. 60/343,863, filed on Dec. 21, 2001.

(51) Int. Cl. G06F 17/60

(52) U.S. Cl. 705/37

(57) ABSTRACT

A method for providing a trading system comprising the steps of accepting selling information request from users and storing those requests, accepting buying information request from users and storing those requests, matching individual stored selling and buying requests according to a similar subset of information contained in respective selling and buying information requests, passing matched information to a trading station where the match information is announced, accepting one of the selling and buying information from the trading station if the selling or buying information accepted is better than one of the buying and selling information matched and announced, reporting back to the users one of the results of the original match when no acceptance occurs and the results of the acceptance when any one of the selling or buying information is accepted from the trading station.

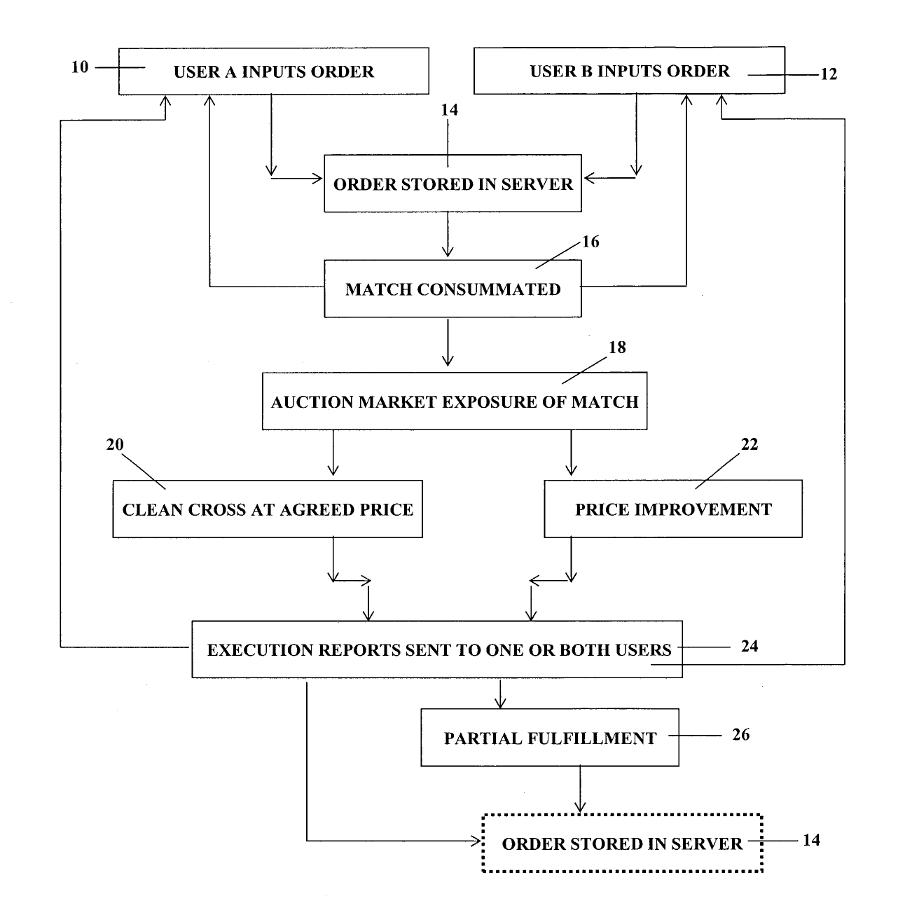

Applicant claims priority of Provisional U.S. Patent Application No. 60/343,863 filed Dec. 21, 2001.

### BACKGROUND OF THE INVENTION

The present invention relates to a system designed to provide confidential and anonymous matching of interest in financial instruments that exposes the matched interest to an auction market pricing mechanism to determine the price of the matched quantity to be traded. The preferred embodiment of the system relates to the trading of large “blocks” of listed equity securities, i.e., lot sizes of 10,000 shares or greater that trade on the floor of the New York Stock Exchange (NYSE), but other embodiments relate to the trading of smaller quantities of shares, listed equities of other exchanges, non-listed equities, derivatives, fixed income securities and other types of securities. The system combines the benefits of an auction market, such as the NYSE, or other floor-based exchange systems and/or electronic auction systems, with the innovations afforded by electronic trading systems. The preferred embodiment of the system is directed to bridging the chasm that currently exists between automated trading systems (ATS) market penetration of Nasdaq and NYSE-listed stocks.

At the present time, block trades constitute a large portion of volume on stock exchanges. For example, approximately 50% of NYSE trading volume consists of block trades of 10,000 shares or more, while trades of 25,000 shares or more account for 29% of total volume. Over 5.5 million block transactions, comprising trades of 10,000 shares or more, totaling 135.8 billion shares, were traded in 2000 on the NYSE. Since many large trades are broken up into smaller pieces in order to mask trading behavior, the potential number of block trades may be even larger than these estimates.

These block trade transactions are driven primarily by institutional investors who are trying to accumulate or unwind large positions. Historically, these institutional investors have relied on sell-side broker-dealers as a source of liquidity to complete such large block trades. Broker-dealers provide liquidity primarily by (i) “shopping” an order to other institutional investors with the hope of matching it with contra side interest (and in the process earning two commissions) and (ii) acting as the counterparty themselves by committing their own capital to take the other side of the investor's trade, typically pricing the stock at a premium or discount as compensation for risking an adverse market move. If the broker-dealer is unwilling to commit capital to facilitate all or part of the trade or cannot find the other side of the trade, typically it would “work” all or part of the order on the NYSE floor.

While providing necessary liquidity, each of these sell-side services also has certain costs, both perceived and real. Most notable among these costs are market impact and opportunity costs. Market impact costs may result from the revelation of the identity of the investor and exposure of the order's side and size to a broker-dealer who may front-run the order, or whose “shopping” of the order to other investors or “working” of the order on the floor may result in a market reaction or in front-running by other market participants. If the broker-dealer is committing its own capital rather than “shopping” the order, it will likely demand to be compensated for providing the liquidity by buying or selling the block at a favorable price, another form of market impact cost. Opportunity costs may also arise from unfavorable price movement while waiting to execute an order due to concern of potential market impact. In short, the lack of anonymity/confidentiality, risk of information leakage and non-automated nature of the traditional “upstairs” block-trading process create real transaction costs for institutional investors.

In an attempt to minimize these types of trading costs through automation and confidentiality, as well as address certain other market needs, a number of liquidity-seeking, automated trading systems have been developed over the years. In the mid-1980s, both Instinet and Investment Technology Group (ITG) launched electronic matching systems, while the late 1990s witnessed the proliferation of electronic communication networks (ECNs) such as Archipelago and Island and other ATSs following the adoption of Reg. ATS. In general, all of these systems started with the premise that the primary markets are flawed and an off-exchange alternative is necessary. Although many of these systems, nevertheless, have links to the primary market and its pricing mechanism (e.g., ITG's POSIT “borrows” prices from the Nasdaq and NYSE in order to assign midpoint pricing for its matched trades before posting such trades on the Consolidated Tape and often routes residuals over DOT to the floor of the NYSE), these links are merely cursory and have never involved direct integration with the NYSE floor's auction pricing mechanism. While these systems have indeed addressed certain shortcomings of traditional block trading, they have also eliminated some of the principal benefits of the “upstairs” and auction markets, such as the opportunity for price improvement through maximum order interaction and the flexibility that accompanies human interaction.

Moreover, ATSs and ECNs have addressed certain segments of the market better than others, leaving large segments virtually untouched. For instance, while ATSs have captured nearly one-half of the total Nasdaq trade volume, they have taken very little volume away from NYSE-listed stocks. In fact, most estimates suggest that they have garnered less than 5% of NYSE volume to date, while only 17% of the volume in NYSE-listed stocks traded outside of the NYSE in 2000, including that completed via ATSs, ECNs, the regional exchanges and the over-the-counter market. This disparity in ATS penetration exists despite the fact that the market capitalization of NYSE-listed companies is nearly quadruple those of the Nasdaq.

In an effort to fend off competition from ECNs that offer automated trading and greater anonymity, the NYSE has accommodated institutional investors' demands for technological innovation. Its recent Network NYSE and Institutional Xpress offerings demonstrate these efforts. In addition, decimalization, while narrowing spreads, has exacerbated the perception problem surrounding NYSE specialists and increased the perceived dangers of exposing interest to the NYSE floor. With stocks trading in smaller increments (quoted to pennies), there are more price points for specialists and other market participants to step in front of, making front-running and breaking up crosses easier and less risky because only a penny ($.01) is at risk rather than a minimum of a sixteenth ($.0625). Moreover, with less depth at any one price, traders must either spread a large order among more price points or seek dealer capital commitment to price an entire block. The result of the fears of being “pennied” and less depth in market has been a marked increase in non-agency trades away from the floor of the NYSE, according to numerous floor participants.

Institutions have also become increasingly aware of transaction costs and their impact on investment returns. In fact, institutions are actively engaged in efforts to reduce implicit or “hidden” trading costs, such as market impact. Some studies suggest that these non-commission costs can represent an estimated 75-90% of total transaction costs, dwarfing actual commission costs, and average $.44 and $.77 per share for large and small cap stocks, respectively. In addition, several mergers by institutional investors have created larger pools of capital, resulting in an even greater need for confidential large block trading.

Objects, advantages and novel features of the present invention will become apparent from the following detailed description of the invention when considered in conjunction with the accompanying drawings.

### DETAILED DESCRIPTION OF THE DRAWINGS

A trade involving the system of the present invention proceeds in two fundamental stages. In the first stage, buyers 10 and sellers 12 enter orders into the confidential and anonymous trading system 14 (in which no one else sees the side or size of their order or gets to know their identity) with the hope of matching with the contra-side. In the second stage, once a buyer and seller are matched by the confidential and anonymous system 16, the matched quantity is sent to the floor 18 of an auction-based exchange, such as the NYSE, for potential price improvement. An important feature of the present invention is the second stage in which the matched quantity is sent to an auction floor 18 or electronic auction for potential price improvement. The first stage results in the discovery of the volume the users of the system wish to trade by using electronic matching 16; the second stage allows the floor 18 to discover the price at which the trade will be executed.

The design of the present system provides both anonymity and confidentiality, which are distinct concepts. An anonymous order does not reveal the identity of the person giving the order, while a confidential order additionally protects the size and side of the order. For instance, most ECNs offer users anonymity by not revealing who is behind the bid or offer, but still require users to indicate whether they are bidding or offering the stock and in what size, and thus do not offer complete confidentiality. The system provides anonymity and confidentiality to all participants in the trading process. System clients will not have access to any information input by another client concerning the nature, size, or price criteria for the other client's interest. In addition, once a match has been made, the system exposes only market-neutral information to the floor since a cross by its nature is comprised of equal buy and sell interest. This is in sharp contrast to the amount of information that would be revealed if a broker-dealer were “working” an order on the floor, thereby revealing one-sided interest. The system will, thus, be able to limit the movement of a stock's price between the time an order is entered and when it hits the floor, and the trade is completed. In addition, enhanced anonymity/confidentiality will facilitate brokers' and specialists' efforts to shop working orders without identifying the source or trading intentions.

The system works through a standard personal computer interface or other electronic input device 10, 12, such as a hand-held device. A system transaction for exchange-listed equity blocks would begin, for example, when a user, following the system menu prompts and protocols, enters (i) the name or symbol of the stock in which he wants to trade, (ii) the size of his total buying or selling interest, (iii) the time the order is to remain in force (e.g. Day, Immediate or Cancel) and (iv) the type of order such as a Market Order or Limit Order. Entering a limit price may effectively establish a price variation tolerance (or discretion), permitting a transaction to be concluded at a downward price variation for sellers and an upward price variation for buyers, within the tolerance limits set by the client if there is price competition on the floor. Alternatively, in another embodiment, the system may allow users to enter nonbinding indications of interest rather than binding orders at this stage and later give the users a chance to confirm their interest when the contra side is found, at which time the indication of interest becomes a binding order.

Each user will be able to follow and edit his buying or selling information on his PC screen. However, none of the system users will know what the potential buying or selling interest is for any other user at any time. No user's screen will show and no user will have access to any information which is inputted by any other user concerning the nature, size or price criteria for such other user's interest. No user will be aware of any other user's identity. Thus, the system will be both anonymous and confidential.

All buying and selling interest entered into the system will be collected in the system's pending interest file, which will be continuously searched for potential matches. The system will identify matched buy and sell interest by time priority and limit prices and, as soon as the system locates the match (the lesser of the buyer's and seller's interest), it will determine a “reference price,” which will be the price at which the system will attempt to cross stock on the exchange floor or other auction market, whether electronic or floor-based. It is currently contemplated that the reference price will be the midpoint between the quoted bid and ask for the stock at the time the two sides are matched, although other reference prices such as last sale could be used alternatively. In another embodiment, the system will at this point notify both users that they have been matched with another user for a certain number of shares.

The paired trade information is immediately entered in the system's pending execution file and is routed electronically or verbally 18 to a broker on the exchange floor (or in another embodiment directly to the specialist's post on the floor) as an order for a proposed cross, perhaps under NYSE rule 72(b) or the “size based on precedence rules” if either is applicable. The executing broker (or the specialist in another embodiment) then announces to the crowd that he wants to cross at the reference price, and asks the crowd if anyone offers price improvement. If no price improvement is offered, the paired buy-sell is immediately completed as a cross 20 (under Rule 72(b) if applicable), and the execution is electronically or verbally reported 24 to the system users 10 and 12.

However, if price improvement is offered in the crowd, the executing broker holding the proposed cross can compete in price up to the limits of the price discretion already given by the respective client, allowing the cross to be completed if the discretion matches such price improvement 22 and the executions reported to both clients 24. If the affected client's discretion is willing to compete with the crowd, the trade is completed as a cross but, if not, the side of the proposed cross benefiting from the crowd's price improvement will be executed as a standard buy or sell in the crowd 22. In this case, the other side of the original proposed match will be automatically re-entered into the system's pending interest file as a continuing desire to buy or sell on a time priority basis at the latest sale reference price 14, unless the system client changes or withdraws his pending interest. In another embodiment, if prices offered in the crowd are beyond the pre-set price discretion limits, the executing broker may also be able to signal the system or notify the respective client to report the price movement to the respective client and inquire whether the discretion limit is changed to permit the cross to be completed at the higher or lower price being offered in the crowd.

Whenever a client order is executed, the size of the client's remaining interest as previously recorded in the system is automatically adjusted 26. The client can also adjust the size of his interest at any time if a portion of his interest is executed in another market. He can also withdraw his entire interest if market conditions or other considerations so dictate.

The system of the present invention is designed to work cooperatively with exchanges, such as the NYSE and its member firms. This approach will bring a new source of liquidity to an electronic trading forum and allow the system to be used as a utility for block trading by all market participants. By bringing the benefits of confidential electronic trading to the primary market without disintermediating key market participants, the system will enable all market participants for the first time to access the liquidity of an exchange floor, such as the NYSE, on level playing field terms, i.e., without having to work a one-sided order on the floor, which would expose investment intention and risk price impact.

The present system is also directed to sell-side brokers and floor participants who are expected to actively use a confidential matching system that does not disintermediate them but, rather, addresses their needs. Since this system will enhance, not replace, traditional “upstairs” brokers and the floor brokers and specialists who operate on the auction floor, and thereby limits disintermediation, these participants are expected to contribute their liquidity to the system and utilize the system's liquidity to meet their own trading objectives.

The confidential matching system of the present invention attempts to pool the liquidity of all three broad classes of participants who trade listed stocks: institutional investors, broker-dealers and floor participants (i.e., floor brokers and specialists). In contrast to the currently available systems, which are generally only effective in accessing the liquidity of one of the three segments, the present system attempts to include “upstream” liquidity from the floor, which will constitute a unique source of liquidity for system. Inclusion of all three legs of liquidity maximizes liquidity and the interaction of order flow and, accordingly, the system is designed so as not to forego any of these pools. The system ensures that the playing field is level and no one category of participants will benefit disproportionately from the system design.

While numerous ECNs and ATSs have emerged in recent years, none are directly integrated with the primary market. As a result, they cannot provide access to the pricing mechanism of the NYSE floor. Instead, they either attempt to discover prices on their own or “borrow” prices from the primary market. While each of the various alternatives has its own merits, the only way only way to ensure the best pricing for any order is to expose the order to maximum interaction in the market, not just one fragmented pool of liquidity. In the case of NYSE-listed stocks, this requires exposing orders to the floor, where nearly 85% of listed volume resides. Thus, the present system chooses to expose its matches to the floor of the exchange so that there is an opportunity for price improvement for each side of the order. Even if a new price is not “discovered”, participants receive price validation and comfort in the form of a NYSE execution, which they cannot get if the cross were executed away from the NYSE. There are many institutions that value the benefits of the auction market and some require a broker-dealer to send a cross to the floor rather than off-exchange in order to validate that the pricing is fair. Operation in conjunction with the NYSE auction market and its price discovery mechanism offers price validation and/or potential price improvement for all crosses. Whereas ECNs and ATSs operate using their own off-market price discovery processes, system participants will benefit by having the established NYSE price discovery process incorporated in every cross.

In contrast to certain other crossing networks, the matching system of the present invention will operate continuously, which offers traders constant trading capability as opposed to pre-set matching sessions. This will not only benefit traders from the perspective of offering more trading opportunities, but also reduces the risks associated with call markets. The risk of adverse selection to a trader using the present system can be minimized because the system does not require orders to be left there indefinitely, which would subject the trader to being “picked off” if news on the stock was released while he was “stuck” in the system. Even if an order were to be left in the system without a limit, the connection with the primary market would reduce the risk of being “picked off” because the match would only cross successfully at a true market price. The match is sent to the floor with a reference price derived from the primary market and then must be crossed in front of the trading crowd, which will, in essence, offer price protection to both parties since the crowd will bid higher for stock that has been “under-priced” in light of new information that has been released regarding the stock or offer lower if the reverse is true. A further benefit of a continuously operating matching system is that users can work the orders through multiple liquidity sources simultaneously, which offers users more control and is less disruptive of the current block trading paradigm.

The business model contemplated by the system of the present invention is that of a private utility. The system will provide open access to its block trading tool to all market participants on a level playing field and the system will be compensated via a metered “toll” charge or commission for each transaction. Although the system may be registered as a broker-dealer for regulatory purposes, the system is not expected to be self-clearing and will not follow the traditional broker-dealer business model, i.e., actively soliciting commission business from buy-side institutions at the expense of other broker-dealers. In fact, buy-side institutions will be encouraged to designate other brokers when using the system since the system will be paid its small commission even if another broker-dealer is selected.

In a principal capacity, the sell-side has the same incentive to use the system of the present invention as the buy-side—it will provide a way to move large blocks of listed stocks in a confidential and anonymous manner that minimizes market impact (while still providing a potential for price improvement). However, the need for such a system may be even greater for the sell-side than the buy-side.

As part of their customer facilitation business, broker-dealers often need to reduce or liquidate their inventory of positions accumulated through their commitment of capital. They need to do this in order to reduce the amount of capital they have tied up and/or minimize their exposure to the market or a particular stock in a speedy, confidential manner that minimizes the revelation of their positions to other market participants (who are well-aware that they would want to liquidate the position as soon as possible). Listed block traders lack a tool by which they can unwind such positions cost effectively, controlling their inventory without risking the revelation of sensitive trading information.

The NYSE floor consists of two primary groups—floor brokers and specialists. The category of floor brokers can be further divided into (i) floor brokers who work for an NYSE member firm's upstairs trading desk and transact orders for the firm (as a principal) or its customers (as an agent) on the exchange floor and (ii) independent, or “two-dollar,” brokers who operate on an independent basis rather than as representatives of a specific firm and execute orders on behalf off-side institutions and/or sell-side brokers, particularly when anonymity is a primary concern. Because non-independent floor brokers share many similar interests to their upstairs colleagues (and in essence represent the same liquidity pool), independent brokers are the focus of the remainder of the discussion. These professionals derive significant income from executing large block trades. Floor participants prefer a solution that will protect their long-term viability by including them in an electronic trading environment rather than bypassing them.

One of the most distinguishing aspects of the system of the present invention is that it is designed to address the needs of these floor participants in addition to the traditional ATS targets of the buy-side and sell-side. Floor participants represent a virtually untapped group of potential ATS users and source of liquidity. Principal trades by specialists accounted for 27.5% of total NYSE share volume in 2000 alone. Neither specialists nor independent floor brokers utilize ATSs or ECNs at all during market hours today. There are practical and legal reasons for this fact. First, specialists and independent floor brokers do not want to support products that cross blocks of stock off-exchange and thereby contribute to a decline in NYSE volume, which is the source of their respective livelihoods. Second, complying with certain regulations make intra-day off-exchange trading impractical despite the repeal of NYSE Rule 390. These two factors make the system the only anonymous liquidity-seeking system that all floor participants can use intra-day legally and practically speaking.

It is believed that there is a real demand for such a confidential matching system. Specialists would use the system heavily to move unwanted inventory in a confidential manner, particularly with respect to illiquid stocks that often tie up specialists' capital and subject them to unwanted market risk. The system will provide an intraday secure vehicle that specialists can use to unwind large and/or illiquid positions in listed stocks without revealing their investment intention. This will bring a previously hidden source of liquidity to institutions and broker-dealers. Since the trades will be executed on the exchange, independent brokers should also be comfortable using the system as an additional tool to shop working orders on behalf of their clients without revealing their underlying identities or trading intentions, which is consistent with their charge to protect the confidentiality of their clients.

The move to decimalization makes the present system particularly timely and even more likely to garner support from the NYSE and its specialists. Less depth in the market and fears of being “pennied” and having crosses broken up have resulted in a marked increase in non-agency trades away from the floor, according to numerous floor participants. Although decimalization in theory also increases the risk that crosses in the proposed system can be broken up, there are several reasons that this problem is likely to be minimal. First, a recent proposed NYSE rule change will prohibit specialists from breaking up crosses greater than 25,000 shares, the typical system trade. Second, since system crosses are expected to be large in size, breaking up a substantial part of the order could, in fact, be potentially costly for the party attempting to do so, and the specialist would, in all likelihood, “clean up” any small orders standing in the way of a large cross in order to put the cross “on the tape” in tact, which enhances his and the NYSE's franchise. Third, the system is designed with a default amount of “volume discretion” for crosses, e.g., that the executing broker should give up 10% of the volume of the cross in order to have the remainder printed at the matched reference price rather than re-pricing the entire block by competing.

The present system will be a real-time, scalable, secure, distributed transaction processing system based on industry standard components. The system incorporates messaging middleware (i.e., asynchronous, publish and subscribe), in-memory and relational database technology, and vertically scalable multi-processor server-class machines. The system provides security at multiple levels through the use of firewalls, encryption, authorization, and authentication schemes, and will support standard communications protocols including TCP/IP and FIX to permit the widest possible access to and from clients.

Users will be able to access the system by a variety of electronic means, e.g. (i) a stand-alone browser-based user interface, (ii) an order management system (OMS) provided by the leading vendors or, in the case of certain key customers, a proprietary OMS and (iii) the interfaces of preferred distribution partners.

While the preferred embodiment shows use of the invention on stock market exchanges, it could be used to effectuate commodities trading, auctions, etc.

Although the present invention has been described and illustrated in detail, it is to be clearly understood that the same is by way of illustration and example only, and is not to be taken by way of limitation. The spirit and scope of the present invention are to be limited only by the terms of the appended claims.

What is claimed

1. A trading system comprising:
at least one input device for receiving selling information,
at least one input device for receiving buying information,
a comparison device coupled to the at least two input devices for comparing the selling and receiving information and reporting out match information between selling and buying information to a trading station and where the match information is announced,
at least one input device at the trading station for receiving one of a better selling or buying information then announced,
an execution device which receives the match information and any input from the input device at the trading station reports back to the input devices of the matched selling and buying devices one of a plurality of messages including the original match information when no input is received from the input at the trading station or a revised match information using the input from the input device at the trading station to replace one of the matched selling and buying information from the matched information.

2. The trading system of claim 1 wherein information moves between devices utilizing hard wiring fiber optics transmission.

3. The trading system of claim 1 wherein information moves between devices utilizing wireless transmission. [Note: we should make sure that any and all information transmitted can also be done by a human being verbally]

4. The trading system of claim 1 wherein information moves between evices by a human verbal communication.

5. The trading system of claim 1 wherein the execution device can accept partial match information from the trading station and reports back to the input devices of the matched selling and buying input devices the revised information containing that portion of the original matched information left over after the input from the trading station and the matched information from the trading station.

6. The trading system of claim 1 wherein the execution device includes a storage device for receiving the inputs from the input devices for receiving selling information and buying information.

7. The trading system of claim 5 wherein the execution device includes a storage device for receiving the inputs from the input devices for receiving selling information and buying information.

8. The trading system of claim 6 wherein the storage device receives the replaced information from the execution device when there is input from the input device at the trading station.

9. The trading system of claim 7 wherein the storage device receives the replaced information from the execution device when there is input from the input device at the trading station.

10. A method for providing a trading system comprising the steps of
accepting selling information request from users and storing those requests,
accepting buying information request from users and storing those requests,
matching individual stored selling and buying requests according to a similar subset of information contained in respective selling and buying information requests,
passing matched information to a trading station where the match information is announced,
accepting one of the selling and buying information from the trading station when the selling and buying information accepted is better than one of the buying and selling information matched and announced,
reporting back to the users one of the results of the original match when no acceptance occurs and the results of the acceptance when any one of the selling or buying information is accepted from the trading station.

11. The method of claim 10 wherein the accepted information from the trading station replaces information from the original match and wherein the replaced information is returned to be stored with other selling and buying information from users.

12. The method of claim 10, wherein the accepted information can be of a lesser amount of one of the matched similar information.

13. The method of claim 11, wherein the accepted information can be of a lesser amount of one of the matched similar information.

14. The method of claim 12, wherein the original users will receive information about both the lesser amount and the original amount less the lesser amount.

15. The method of claim 13, wherein the original users will receive information about both the lesser amount and the original amount less the lesser amount.
